(19) United States
(12) Patent Application Publication
(10) Pub. No.: US 2008/0262186 A1
(43) Pub. Date: Oct. 23, 2008

(54) Catalysts for the Production of Polyisocyanates

(75) Inventors: Janis Louie, Salt Lake City, UT (US); Hung A. Duong, Salt Lake City, UT (US); Michael J. Cross, Salt Lake City, UT (US)

Correspondence Address: THORPE NORTH & WESTERN, LLP., P.O. Box 1219, SANDY, UT, 84091-1219, US

(73) Assignee: University of Utah Research Foundation, Salt Lake City, UT (US)

(21) Appl. No.: 11/596,969

(22) PCT Filed: May 19, 2005
(86) PCT No.: PCT/US05/18063

§ 371 Date: Dec. 26, 2007

Related U.S. Application Data
(60) Provisional application No. 60/572,316, filed on May 19, 2004.

(51) Int. Cl. C08G 18/20

(52) U.S. Cl. 528/53; 528/52

(57) ABSTRACT

Disclosed is a method for making oligomeric and polymeric isocyanates, particularly uretdiones and isocyanurates, by reacting diisocyanates in the presence of a catalyst, wherein the catalyst comprises either free N-heterocyclic carbenes, imidazolylidene carboxylates, triazolylidene carboxylates, or salts thereof.

### CROSS-REFERENCE TO RELATED APPLICATION

This application claims the benefit of U.S. Provisional Patent Application No. 60/572,316, filed on May 19, 2004, the entirety of which is incorporated by reference.

### TECHNICAL FIELD

This invention relates to polymer chemistry, more specifically, the invention relates to a method for making oligomeric and polymeric isocyanates by reacting diisocyanates in the presence of a catalyst, wherein the catalyst comprises an imidazolylidene complex or triazolylidene complex.

### BACKGROUND

The references and discussion herein are provided solely for the purpose of describing the field relating to the invention. Nothing herein is to be construed as an admission that the references or statements constitute prior art or that the inventors are not entitled to antedate a disclosure by virtue of prior invention.

Oligomerization of isocyanates (organic compounds that have the functional group that results from a nitrogen being double bonded to a carbon which is double bonded to a oxygen, —N═C═O, also referred to as the NCO group) is a long-known, generally accepted method of modifying low molecular weight isocyanates. The modified isocyanates, which are usually at least difunctional (compounds having more than one functional group), may then be used to obtain products with advantageous application properties (e.g., polymers, and paint coatings). Multifunctional isocyanates will generally be referred to as polyisocyanates in this specification.

Polyisocyanates based on aliphatic (non-aromatic compounds) diisocyanates are normally used for light-resistant, non-yellowing paints and coatings. The alkyl and allyl groups are subsets within the category of aliphatic compounds. The term “alkyl” refers to a straight or branched chain saturated hydrocarbon (e.g., having no double bonds). Examples of alkyl groups are: methyl, ethyl, 1-propyl, 2-propyl, 1-butyl, 2-butyl, 1-pentyl, 3-pentyl, and the like. An allyl group is a straight or branched hydrocarbon chain having at least one double bond, for example, having the structure of CH₂═CH—CH₂—. One type of non-aliphatic compounds are aryl compounds. The term “aryl” refers to an unsubstituted or a substituted phenyl group. Examples of aryl groups are benzene, 2-methylbenzene, 3-chlorobenzene, 4-hydroxybenzene, 3-methoxybenzene, methoxybenzene, 3-nitrobenzene, 2-trifluorobenzene, and the like. The terms “aliphatic,” “alkyl,” “allyl,” or “aryl,” refers to the carbon atoms to which the NCO groups of the monomer are bonded, e.g., an aliphatic compound molecule may contain aromatic rings, but not at the atom of connection between the group and the isocyanate.

One can distinguish between different products and processes according to the main type of structure formed from the previously free NCO groups in the respective oligomerization reaction. Particularly important procedures involve the dimerization and trimerization of the NCO groups to afford uretdiones and isocyanurates (or iminooxadiazindione structures), respectively.

Isocyanurates, the aromatic product arising from cyclotrimerization of isocyanates, are used to enhance the physical properties of a wide variety of polyurethanes and coating materials [1]. The addition of isocyanurates to these polymeric blends leads to increased thermal resistance, flame retardation, chemical resistance, and film-forming characteristics [2]. Furthermore, triaryl isocyanurates (isocyanurates as in FIG. 3 where all of the “R” groups are aryl groups) are often used as an activator for the polymerization and postpolymerization of ε-caprolactam in the production of a nylon-6 with a high melt viscosity [3]. Triallyl isocyanurate (isocyanurates as in FIG. 3 where all of the “R” groups are allyl groups) is used in the preparation of flame-retardant laminating materials for electrical devices as well as in the preparation of copolymer resins that are water-resistant, transparent, and impact-resistant [4].

The commercial importance of isocyanurates has lead to considerable effort in developing effective methods for the cyclotrimerization of isocyanates. Numerous catalysts have been discovered that facilitate this reaction [5]. Lewis base catalysts include phosphines [6], amines [7], NO [8], alkoxyalkenes [9], and anions such as p-toluenesulfinate [10], cyanate [11], fluoride [12], and carbamate [13]. Organometallic compounds, which may alternatively proceed through a Lewis acid catalyzed pathway, include oragnotin compounds [14], alkylzinc amides and alkoxides [15], and copper(II) and nickel(II) halides [8]. Unfortunately, most of these procedures suffer from 1) severe reaction conditions, 2) poor selectivity and a high formation of by-products, 3) functional group incompatibility, and 4) difficulty in the removal of the catalysts and additives. To date, the most effective catalyst for the cyclotrimerization of both aryl and alkyl isocyanates is an extremely basic tethered phosphine [16].

An idealized example of the uretdiones (dimer) and isocyanurates (trimer) formed from cyclohexyl isocyanates is provided in FIG. 1. If a different isocyanate had been used, for example phenyl isocyanate, then the two products shown in FIG. 1 would have phenyl groups in place of the cyclohexyl groups. Or if a diisocyanate had been used then the uretdiones and isocyanurates formed would have free NCO groups available for later reactions. For example, if cyclohexyl diisocyanates was the reactant, then the uretdiones and isocyanurates would have cyclohexyl groups bound to the ring nitrogens, as in FIG. 3, but would also have unreacted NCO groups attached to the cyclohexyl groups. Iminooxadiazindione structures, illustrated in FIG. 4, are another type of trimer that results from isocyanate trimerization.

When this specification refers to trimers it is referring to isocyanurates, iminooxadiazindione structures, and isomers of each. Similarly, when this specification refers to dimers it is referring to uretdiones and the corresponding isomers. The term “oligomerization” refers to all types of modification.

Additionally, any time dimer or trimer is referred to as a reaction product the opposite is almost always also present in low quantities. For example, whenever trimers are the predominant reaction product, there will be low amounts of uretdiones present.

Dimers based on aliphatic diisocyanates have a far lower viscosity than trimers. Trimers on the other hand have the higher functionality required for a high crosslink density in the polymer and consequent good stability properties thereof. Their viscosity increases very rapidly though with increasing conversion in the reaction. Compared with isomeric isocyanurates, iminooxadiazindiones have a far lower viscosity with the same NCO-functionality of the polyisocyanates resin, though they do not reach the viscosity level of uretdiones.

State of the art for producing polyisocyanates is isocyanate oligomerization using a large number of both saline and covalently structured catalysts. While very small quantities of catalyst are sufficient for isocyanate oligomerization when using compounds with a saline structure, such as fluorides or hydroxides and the desired rate of conversion is achieved in a very short time, higher catalyst concentrations and/or prolonged reaction times are required when using covalently structured trimerization catalysts.

Up until now, just covalently structured catalyst systems have been described for producing polyisocyanates with uretdione structure. Most widespread is the use of trialkylphosphines or pyridines amino substituted in the 4-position.

The disadvantage of the method of the state of the art is that catalysts with saline structures are virtually exclusively capable of generating trimers but rarely forming uretdiones. Uretdione selective catalysts are all covalently structured, for which reason they have to be used in comparatively high concentrations, based on the mass of the catalyst and isocyanate to be oligomerized, and also only lead to relatively slow progress of the reaction. Both of these factors are disadvantageous in terms of cost efficiency and paint technology. More recently, a patent application has been issued where catalysts are saline in structure but highly reactive in dimer formation. U.S. Patent Application US 2003/0078450 A1 “Method for Producing Polyisocyanates”, published Apr. 24, 2003. These catalysts are five-membered N-heterocycles which carry at least one hydrogen atom bound to a ring nitrogen atom in the neutral molecule.

Nitrogen heterocycles are already used in polyisocyanates chemistry as neutral, N—H—, or N-alkyl group-carrying compounds. However, they are generally used as blocking agents for NCO groups or as stabilizers to prevent UV radiation-induced damage to paint film produced from the polyisocyanates. The purpose for including nitrogen heterocycles was not to oligomerize the isocyanate groups, rather the aim was to thermally reversibly deactivate the isocyanate groups to enable single component processing or stabilization of the polyurethane plastic material or paint. Oligomerization of the isocyanate groups would even be disadvantageous in both cases.

### DISCLOSURE OF THE INVENTION

Herein, we report catalysts that are five-membered N-heterocycles. A heterocycle is a cyclic compound where at least one of the atoms in the ring is an element other than carbon. Heterocycles may or may not be aromatic. An N-heterocycle is wherein at least one of the ring atoms is nitrogen instead of carbon. In the inventive process, an additional NH moiety (i.e., the ring nitrogens can be bonded to a functional group other than hydrogen) on the catalyst is not a requirement. Herein, we detail the discovery of imidazolylidene-based catalysts that mediate both the trimerization and dimerization of monomeric isocyanates. These catalysts efficiently polymerize diisocyanates to give a wide range of polymeric material whose physical properties are highly dependent on the catalyst used. We believe that other imidazolylidene based structures will also be viable catalysts and that these imidazolylidenes can be generated in situ from their salt precursors.

During our investigations of the Ni-catalyzed cycloaddition reaction between diynes (hydrocarbon compounds with two triple bonds) and isocyanates, we discovered that N-heterocyclic carbenes (carbenes are neutral molecules in which one of the carbon atoms is associated with six valence electrons) and imidazolium carboxylates react with isocyanates to produce isocyanurates and uretdiones. N-heterocyclic carbenes (NHCs) have been shown to react with isocyanates but afford hydrotains instead of isocyanurates [17]. Herein, we present our discovery of NHC-based catalysts for the cyclotrimerization of alkyl, allyl, and aryl isocyanates to afford isocyanurates, and the dimerization of alkyl, allyl, and aryl isocyanates to afford uretdiones.

The inventive method disclosed herein may use alkyl, allyl, or aryl isocyanates as substrates for catalyzing the formation of isocyanate dimers and trimers. As an example of substrates, phenyl isocyanate and cyclohexyl isocyanate may be used. A variety of N-heterocyclic carbenes were screened as potential nucleophilic catalysts. For the cyclohexyl isocyanate substrate, the predominant product obtained with most of the NHCs catalyst was a dimerized product rather than the isocyanurate. Interestingly, reactions run with phenyl isocyanate did not follow the same pattern of reactivity, but produced the trimer. For the cyclohexyl isocyanate substrate, many of the NHCs produced the dimer. For example, IMes (FIG. 2, compound 1), IAd (FIG. 2, compound 4), ItBu (FIG. 2, compound 5, and iPrim (FIG. 2, compound 7) all gave the dimerized product quantitatively by GC analysis. Not surprisingly, incomplete conversion was observed with sterically hindered IPr (FIG. 2, compound 2) and SIPr catalysts (FIG. 2, compound 3). Regardless of the isocyanate substrate used ICy cyclotrimerized both aryl and alkyl isocyanates. Also, iPrim produced both the dimer and the trimer with cyclohexyl isocyanate as the substrate. No reaction was observed for either aryl or alkyl isocyanates in the absence of N-heterocyclic carbene catalyst.

NHCs react with CO₂ to form imidazolium carboxylates. The bottom reaction pathway catalyst of FIG. 1 illustrates the imidazolium carboxylate that results from the reaction of ICy (FIG. 2, compound 6) with CO₂. These imidazolium carboxylates are also effective catalysts for the cyclotrimerization of isocyanates. For example, iPrimCO₂ readily cyclotrimerized phenyl isocyanate quantitatively. Different reactivity was observed between reactions run with ICy versus ICyCO₂. The cyclotrimer product of cyclohexyl isocyanate was the main product when ICy was used as the catalyst. In contrast, ICyCO₂ mainly afforded dimer products. Additionally, the inventive method disclosed herein may be used to form polymers from diisocyanates. As an example, NHC catalysts proved to be effective in the homopolymerization of diisocyanates such as 1,6-diisocyanatohexane.

The monomer of the invention may be PhNCO, CyNCO, Allyl-NCO, (o-CH₃)C₆H₄—NCO, (p-MeO)C₆H₄—NCO, 1,6-diisocyanatohexane, or a combination thereof, which may be used in combination with a catalyst of the invention, which include, but are not limited to, IMes, IPr, SIPr, LAd, ItBu, ICy, iPrim and/or a combination thereof, and the method of the invention provides a trimer or dimer polymerization yield of at least 2%, 4%, 11%, 14%, 18%, 23%, 54%, 55%, 58%, 60%, 62%, 64%, 85%, 90%, 95%, 97%, 98%, and of at least 99%, and/or a yield as shown in Table 1, Table 2, or Table 3. Optionally, the catalyst may be generated in situ.

With the invention, lower temperatures and lower catalyst loadings can be used while achieving higher selectivity.

### BRIEF DESCRIPTION OF THE DRAWINGS

FIG. 1 is a graphical illustration of a process using an N-heterocyclic carbene and an imidazolium carboxylate.

FIG. 2 is a graphical illustration of some of the N-heterocyclic carbenes referred to herein.

FIG. 3 is a graphical illustration of an N-heterocyclic carbene catalyzing isocyanurate formation.

FIG. 4 is a graphical illustration of an iminooxadiazindione.

FIG. 5 is a graphical illustration of some of the catalysts in the method.

FIG. 6 is a graphical illustration of some of the catalysts in the method.

### BEST MODE OF THE INVENTION

As used herein and in the appended claims, the singular forms “a”, “an”, and “the” include the plural unless the context clearly dictates otherwise. For example, reference to “an isocyanate” includes a plurality of such isocyanates, and reference to the “catalyst” is a reference to one or more catalyst molecules, and so forth.

Various isocyanates, including diisocyanates and triisocyanates may be polymerized. The structural formula of some of the potential isocyanates are shown below.

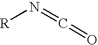

R is H, R₆ (R₆═C₁ to C₂₀ (cyclo and non-cyclo)alkyl, C₁ to C₂₀ (cyclo and non-cyclo)alkenyl, C₁ to C₂₀ (cyclo and non-cyclo)alkynyl, C₆ to C₂₀ aryl, and/or C₁ to C₂ alkoxy), N, NR₆, NR₆R₆, NO₂, OH, fluorine, chlorine, bromine, fluorinated alkyl, fluorinated alkoxy, cyano, carboalkoxy, SR₆ and/or SR₆R₆.

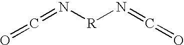

R is H, D (D=C₁ to C₂₀ (cyclo and non-cyclo)alkyl, C₁ to C₂₀ (cyclo and non-cyclo)alkenyl, C₁ to C₂₀ (cyclo and non-cyclo)alkynyl, C₆ to C₂₀ aryl, and/or C₁ to C₂ alkoxy), N or ND, fluorine, chlorine, bromine, fluorinated alkyl, fluorinated alkoxy, cyano, carboalkoxy, SD and/or SD₂.

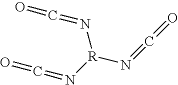

R is H, D (D=C₁ to C₂₀ (cyclo and non-cyclo)alkyl, C₁ to C₂₀ (cyclo and non-cyclo)alkenyl, C₁ to C₂₀ (cyclo and non-cyclo)alkynyl, C₆ to C₂₀ aryl, and/or C₁ to C₂ alkoxy), N or ND, fluorine, chlorine, bromine, fluorinated alkyl, fluorinated alkoxy, cyano, carboalkoxy, SD and/or SD₂.

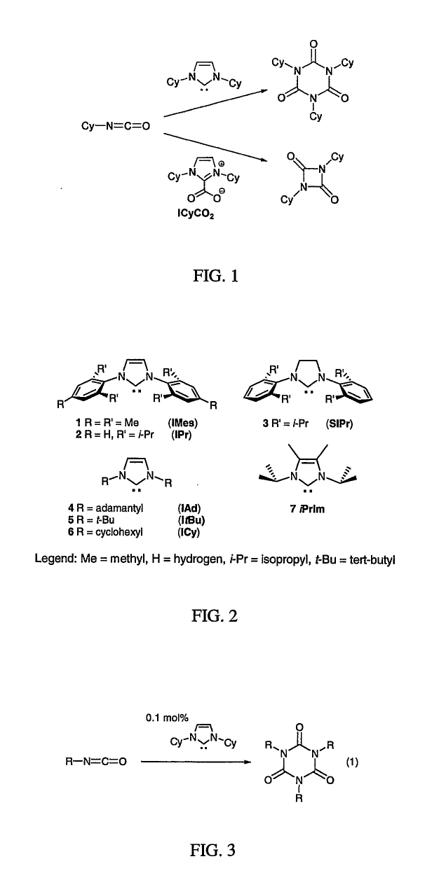

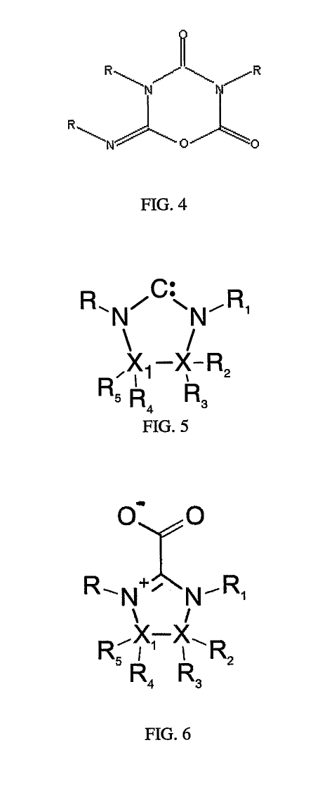

Both phenyl isocyanate (PhNCO) and cyclohexyl isocyanate (CyNCO) were used as model substrates (since alkyl isocyanates typically display different reactivities than their aryl counterparts) and the results are shown in Table 1. FIG. 1 illustrates the structure of the NHC's listed in Table 1.

TABLE 1
NHC-catalyzed Isocyanate Cyclotrimerization^{a}

% Yield^{b}

| Entry | NHC | RNCO | dimer | trimer |
|---|---|---|---|---|
| 1 | None | PhNCO | 0 | 0 |
| 2 | IMes | PhNCO | 0 | 14 |
| 3 | IPr | PhNCO | 0 | 0 |
| 4 | SIPr | PhNCO | 0 | >99 |
| 5 | IAd | PhNCO | 0 | 23 |
| 6 | ItBu | PhNCO | 0 | 54 |
| 7 | ICy | PhNCO | 0 | >99 |
| 8 | iPrim | PhNCO | 0 | 60 |
| 9 | None | CyNCO | 0 | 0 |
| 10 | IMes | CyNCO | 55 | 18 |
| 11 | IPr | CyNCO | 14 | 0 |
| 12 | SIPr | CyNCO | 0 | 95 |
| 13 | IAd | CyNCO | 58 | 0 |
| 14 | ItBu | CyNCO | 64 | 0 |
| 15 | ICy | CyNCO | 62 | 2 |
| 16 | iPrim | CyNCO | 4 | 11 |

^{a}Reactions were run with 1 mol % NHC in THF (RNCO, 0.2M) at room temperature for 3 hours.
^{b}Determined by GC relative to naphthalene as an internal standard.

Further optimization of reaction conditions revealed that a variety of aryl and alkyl isocyanates were effectively converted at room temperature to isocyanurates using only 0.1 mol % ICy as a catalyst (Table 2). The protocol is exceptionally mild as pure isocyanurates were obtained after simply filtering and washing the product from the reaction. When both the substrate and solvent were dry and degassed, quantitative yields were obtained using only a 0.001 mol % catalyst loading (Entry 2). Isocyanates that have only been degassed also readily undergo cyclotrimerization, but at a higher catalyst loading (0.1 mol %, Entry 3). Olefins are inert under the reaction conditions as triallyl isocyanate gave the corresponding isocyanurate in excellent yield (Entry 5). Increasing the steric hindrance of the isocyanate did not prove to be problematic as (o-CH₃)C₆H₅—NCO was converted in 98% yield (Entry 6). It is important to note that even electron-donating aryl isocyanates such as p-OMe-C₆H₄NCO, a sluggish substrate for most cyclotrimerization catalysts, was converted to the isocyanurate in excellent yield (Entry 7).

TABLE 2
Isocyanate Cyclotrimerization catalyzed by ICy.^{a}

| Entry | RNCO^{b} | Yield^{c} |
|---|---|---|
| 1 | PhNCO | 99 |
| 2 | PhNCO^{d} | 98 |
| 3 | PhNCO^{e} | 97 |
| 4 | CyNCO | 99 |
| 5 | Allyl-NCO | 98 |
| 6 | (o-CH₃)C₆H₄—NCO | 97 |
| 7 | (p-MeO)C₆H₄—NCO | 85 |

^{a}Reactions were run with 0.1 mol % catalyst in benzene (0.5M).
^{b}Isolated Yields (average of at least two runs).
^{c}Isocyanates were degassed and dried prior to cyclotrimerization.
^{d}Reaction run neat with 0.001 mol % catalyst.
^{e}Degassed but not dried PhNCO was used.

Although a number of N-heterocyclic carbenes are indefinitely stable under inert atmosphere, they can be easily generated in situ from the appropriate precursor salt and base. Such a method has been used in a variety of metal-mediated reactions including olefin metathesis [18], the Suzuki-Miyaura reaction [19], the Buchwald-Hartwig amination [20], and the Kumada-Corriu reaction [21]. For example, PHNCO was subjected to catalytic amounts of IPrBF₄ (1 mol %), and KOtBu (1 mol %) in THF. Quantitative yield of the cyclotrimerized product was observed by gas chromatography after only 30 minutes at room temperature.

NHCs react with CO₂ to form imidazolium carboxylates and these adducts are also effective catalysts for the cyclotrimerization of isocyanates. For example, iPrimCO₂ readily cyclotrimerized phenyl isocyanate quantitatively. As illustrated in FIG. 3, different reactivity was observed between reactions run with ICy versus ICyCO₂. The cyclotrimer product of cyclohexyl isocyanate was the main product when ICy was used as the catalyst. In contrast, ICYCO₂ mainly afforded dimer products.

As shown in Table 3, all NHCs afforded quantitative yields of polymer. Under identical reaction conditions, a range of physical properties was obtained and was dependent on the specific catalyst that was used.

TABLE 3
Polymerization of 1,6-diisocyanatohexane^{a} catalyzed by NHCs.^{b}

| Entry | Catalyst | Polymer Property | Yield^{c} |
|---|---|---|---|
| 1 | IMes | Cloudy yellow solid | 99 |
| 2 | IPr | Clear yellow solid | 99 |
| 3 | SIPr | N/A | 0 |
| 4 | IAd | N/A | 0 |
| 5 | ItBu | Clear colorless gel | 99 |
| 6 | ICy | White crystalline solid | 99 |
| 7 | iPrim | Clear colorless solid | 99 |

^{a}Diisocyanate was degassed and dried prior to polymerization.
^{b}Reactions were run with 1 mol % catalyst in benzene (0.5M).
^{c}Isolated Yields (average of at least two runs).

Regarding Table 3, N-heterocyclic carbenes (entries 1-6) were prepared using literature procedures [22]. The imidazolium carboxylate (entry 7) was prepared according to literature procedures [23]. Representative procedure for the cyclotrimerization of isocyanates with ICy: Under a nitrogen atmosphere, cyclohexyl isocyanate was added to ICy (0.1 mol %) and the reaction was allowed to stand at room temperature for 30 minutes. The resulting precipitate was filtered, washed with pentane, and dried in vacuo to quantitatively afford the isocyanurate as a white solid.

In addition to all of the compounds previously disclosed in this specification, suitable compounds forming the basis of the catalyst in the inventive method include species of the composition shown in either FIG. 5 or FIG. 6 and herein below.

X and/or X₁ independently of one another represent: Nitrogen (N) or Carbon (C). If X and X₁ are double bonded to each other, if X is doubled bonded to R₂ or if X₁ is double bonded to R₄, then R₃ and R₅ will not exist. Additionally, X and/or X₁ independently of one another may be charged.

R and/or R₁ independently of one another represent: D (D=C₁ to C₂₀ (cyclo and non-cyclo)alkyl, C₁ to C₂₀ (cyclo and non-cyclo)alkenyl, C₁ to C₂₀ (cyclo and non-cyclo)alkynyl, C₆ to C₂₀ aryl, and/or C₁ to C₂ alkoxy), ND or ND₂, NO₂, OH, O₂, fluorine, chlorine, bromine, fluorinated alkyl, fluorinated alkoxy, cyano, carboalkoxy, SD and/or SD₂.

R₂, R₃, R₄, and/or R₅ independently of one another represent: H, D, ND or ND₂, NO₂, OH, O₂, fluorine, chlorine, bromine, fluorinated alkyl, fluorinated alkoxy, cyano, carboalkoxy, SD and/or SD₂; with the proviso that if X is N, then R₂ and R₃ may not be H, or that if X₁ is N, then R₄ and R₅ may not be H.

Additionally, R₂, R₃, R₄, and/or R₅ in combination with each other, independently of one another or together and in combination with X and/or X₁, may form an annellated carbo- or heterocyclic, n-membered ring systems where n=3 to 10, wherein the annellated carbo- or heterocyclic ring systems may, independently of one another, contain one or more heteroatoms (N, O, S) and may be substituted independently of one another by one or more the same or different substituents from the following group: H, D, ND or ND₂, NO₂, OH, O₂, fluorine, chlorine, bromine, fluorinated alkyl, fluorinated alkoxy, cyano, carboalkoxy, SD and/or SD₂.

None of compounds that result from the above paragraphs may include one or more ring nitrogens bonded to a hydrogen, non-ring nitrogens may be bonded to hydrogen.

Other potential suitable compounds forming the basis of the catalyst in the inventive method are carbenes or carboxylate complexes of: pyrroles, substituted pyrroles and carbocyclic and/or heterocyclic annellated derivatives of pyrroles.

Other potential suitable compounds forming the basis of the catalyst in the inventive method are carbenes or carboxylate complexes of: pyrazoles and/or imidazoles, substituted pyrazoles and/or imidazoles and carbocyclically and/or heterocyclically annellated derivatives of pyrazole and/or imidazole.

Other potential suitable compounds forming the basis of the catalyst in the inventive method are carbenes or carboxylate complexes of: 1,2,3- and 1,2,4-triazoles, substituted species of 1,2,3- and 1,2,4-triazoles and carbocyclically and/or heterocyclically annellated species of 1,2,3- and 1,2,4-triazoles.

Other potential suitable compounds forming the basis of the catalyst in the inventive method are carbenes or carboxylate complexes of tetrazoles and substituted tetrazoles.

To produce the catalysts used in the inventive method, in principle all five-membered N-heterocycles may be used which are capable of conversion to a carbene. Examples of such compounds include pyrazole, indazole and substituted derivatives such as 5-nitroindazole, imidazole and substituted derivatives such as 4-nitroimidazole or 4-methoxyimidazole, benzimidazole or substituted benzimidazoles, for example 5-nitrobenzimidazole, 5-methoxybenzimidazole, 2-trifluoromethylbenzimidazole, hetero-aromatic annellated imidazoles such as pyridinoimidazole or purine, 1,2,4-triazole and substituted derivatives such as 5-bromotriazole, heteroaromatic annellated 1,2,3-triazoles such as the isomeric pyridinotriazoles, for example the 1H-1,2,3-triazolo[4,5-b]pyridine—referred to in the remainder of the text as pyridinotriazole—and azapurine, and substituted derivatives of adenine.

The above-mentioned compounds are predominantly routinely used substances which are known from the literature.

Some of the salts of the above-mentioned nitrogen heterocycles are also commercially available, for example in the form of their sodium salts. The optimum “design” of the catalyst with respect to catalytic activity, thermal stability and the selectivity of the reaction for the types of isocyanate oligomer formed may further be adapted to the isocyanate to be oligomerized by appropriate substitution in the heterocyclic five-ring compound.

### REFERENCES

1. Lin et al. Reaction Injection Molding and Fast Polymerization Reactions. Plenum Publishing Corp., New York, 1982. p. 147.
2. a) Wirpsza, Z. Polyrethanes: Chemistry, Technology and Appilcation. Ellis Horwood, London, 1993. b) Zitinkina et al. Russ. Chem. Rev., Vol. 54 (1985), p. 1866. c) Nawata et al. J. Cell. Plast, (1975), p. 267. d) Nicholas, L., Gmitter, G. R. J. Cell. Plast. (1965), p. 85.
3. a) Bukac, Z., Sebenda, J. Chem. Prum, Vol. 35 (1985), p. 361. b) Horsky, J., Kubanek, U., Marick, J., Kralicek, J. Chem. Prum, Vol. 32 (1982), p. 599.
4. a) JP 03,166,255, 1991, Misawa H., Koseki T. b) JP 0309,907, 1991, Hirabayashi, M., Ozawa, S. c) JP 63,122,748, 1988, Sato et al. d) JP 0187,651, 1989, Ishikawa et al. e) JP 0187,649, 1989, Nagai, H., Komya, T. f) DE 3,729,457, 1989, Osturek et al.
5. Frisch, K. C., Rumao, J. P. J. Macromol. Sci. Revs. Macromol. Chem., Vol. C5 (1970), p. 103.
6. a) Tang et al. J. Org. Chem., Vol. 59 (1994), p. 4931. b) U.S. Pat. No. 5,750,629, 1998, Laas et al.
7. Tang et al. J. Org. Chem., Vol. 59 (1994), p. 4931.
8. a) U.S. Pat. No. 4,912,210, 1990, Disteldorf et al. b) Tagachi et al. Bull. Chem. Soc. Jpn., Vol. 63 (1990), p. 3486. c) Richter, R., Ulrich, H. Synthesis, (1975), p. 463. d) Wong, S., Frisch, K. C. J. Polym. Sci. Polym. Chem. Ed., Vol. 24 (1986), p. 2877. e) Kogon, C. J. Am. Chem. Soc., Vol. 78 (1956), p. 4911. f) Wallis, A. F. A., Wearne, R. H. Eur. Polym. J., Vol. 26 (1990), p. 1217.
9. Villa, J. F., Powell, H. B. Synth. React. Metal-Org. Chem., Vol. 6 (1976), p. 59.
10. Mizura et al. J. Polym. Sci., Polm. Chem., Vol. 29 (1991), p. 1544.
11. Moghaddam et al. Bull. Chem. Soc. Jpn., Vol. 75 (2002), p. 851.
12. Tanimoto et al. Bull. Chem. Soc. Jpn., Vol. 39 (1996), p. 1922.
13. Nambu, Y., Endo, T. J. Org. Chem., Vol. 58 (1993), p. 1932.
14. Khajavi et al. J. Chem. Research, Vol. S (2000), p. 145.
15. a) Bloodworth, A. J., Davies, A. G. Chem. Comm., Vol. 24 (1965). b) Bloodworth, A. J., Davies, A. G. J. Chem. Soc., (1965), p. 6858. c) Foley et al. Organometallics, Vol. 18 (1999), p. 4700.
16. Noltes, J. G., Boersma, J. J. Organomet. Chem., Vol. 7 (1967), p. 6.
17. One early reference reports that an NHC reacts with 2 isocyanates to form spiro hydantoins. We see no evidence of the formation of spiro hydantoins in our reactions. See ref: Schössler, W., Regitz, M. Chem. Ber., Vol. 107 (1974), p. 1931.
18. a) Morgan, J. P., Grubbs, R. H. Org. Lett., Vol. 2 (2000), p. 3153. b) Louie, J., Grubbs, L. H. Angew. Chem. Int. Ed., Vol. 40 (2001), p. 247.
19. Zhang et al. J. Org. Chem., Vol. 64 (1999), p. 3804.
20. a) Huang et al. Org. Lett., Vol. 1 (1999), p. 1307. b) Stauffer et al. Org. Lett., Vol. 2 (2000), p. 1423.
21. Huang, H., Nolan, S. P. J. Am. Chem. Soc., Vol. 121 (1999), p. 9889.
22. Henmann et al. Adv. Organomet. Chem., Vol. 48 (2001), p. 1.
23. Duong et al. Chem. Comm. Vol. 1 (2004), p. 112.

1. A process for the polymerization of isocyanates, said process comprising:
providing an effective amount of a catalyst or a salt thereof wherein the catalyst is selected from the group consisting of a N-heterocyclic carbene carboxylate complex of a N-heterocyclic carbene and mixtures of any thereof;
adding to the catalyst or salt thereof an effective amount of a monomer selected from the group consisting of an isocyanate, a diisocyanate, a triisocyanate, a salt of any thereof, and a mixture of any thereof; and
substantially polymerizing the monomer.

2. The process of claim 1, wherein the catalyst is selected from the group consisting of an imidazolylidene complex, a triazolylidene complex, salts thereof, and mixtures of any thereof.

3. The process of claim 1, wherein substantially polymerizing the monomer comprises producing a dimer, trimer, or a combination of a dimer and a trimer.

4. The process of claim 1, wherein substantially polymerizing the monomer comprises producing a uretdione, an isocyanurate, or a combination of uretdione and isocyanurate.

5. The process of claim 1, wherein the catalyst is selected from the group consisting of IMes, IPr, SIPr, lAd, ItBu, ICy, iPrim, iPrimCO₂, ICyCO₂, salts thereof, and combinations thereof.

6-12. (canceled)

19-36. (canceled)

37. The process of claim 36, wherein ha yield of the polymerization is selected from the group of: about 2%, about 4%, about 11%, about 14%, about 18%, about 23%, about 54%, about 55%, about 58%, about 60%, about 62%, about 64%, about 85%, about 90%, about 95%, about 97%, about 98%, about 99%.

38. The process of claim 1, comprising generating the catalyst in situ.

39. The process of claim 1, wherein the catalyst is a triazolylidene carboxylate wherein none of the ring nitrogens are covalently bonded to a hydrogen atom.

40. The process of claim 1, wherein the monomer is phenyl isocyanate, cyclohexyl isocyanate, allyl isocyanate, o-methylphenyl isocyanate, orp-methoxyphenyl isocyanate.

41. The process of claim 1, wherein the monomer is an alkyl, an allyl, or an aryl isocyanate, diisocyanate, or triisocyanate.

42. (canceled)

43. The process of claim 1, further comprising mediating trimerization or dimerization of a monomeric isocyanate with an imidazolylidene-based catalyst.

44. The process of claim 1, wherein providing an effective amount of a catalyst or a salt thereof comprises generating a catalyst having the following structure: 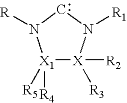
wherein X and X₁ are, independently, a Nitrogen (N) or a Carbon (C) and may carry a charge;
wherein, R and R₁ are, independently, NO₂, OH, O₂, fluorine, chlorine, bromine, fluorinated alkyl, fluorinated alkoxy, cyano, carboalkoxy, R₆, (R₆ being branched or unbranched C₁ to C₂₀ cycloalkyl, C₁ to C₂₀ alkyl, C₁ to C₂₀ cycloalkenyl, C₁ to C₂₀ alkenyl, C₁ to C₂₀ cycloalkynyl, C₁ to C₂₀ alkynyl, C₆ to C₂₀ aryl, or C₁ to C₂ alkoxy), NR₆, NR₆R₆, SR₆ or SR₆R₆;
wherein R₂, R₃, R₄, and R₅ are, independently, H, R₆, NR₆, NR₆R₆, NO₂, OH, O₂, fluorine, chlorine, bromine, fluorinated alkyl, fluorinated alkoxy, cyano, carboalkoxy, SR₆ or SR₆R₆; with the proviso that if X is N, then R₂ and R₃ may not be H, or that if X₁ is N, then R₄ and R₅ may not be H;
with the proviso that if X and X₁ are double bonded to each other, if X is doubled bonded to R₂ or if X₁ is double bonded to R₄, then R₃ and R₅ will not exist.

45. The process of claim 1, wherein providing an effective amount of a catalyst or a salt thereof comprises generating a catalyst having the following structure: 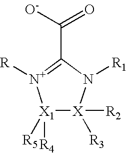
wherein X and X₁ are, independently, a Nitrogen (N) or a Carbon (C) and may carry a charge;
wherein, R and R₁ are, independently, NO₂, OH, O₂, fluorine, chlorine, bromine, fluorinated alkyl, fluorinated alkoxy, cyano, carboalkoxy, R₆, (R₆ being branched or unbranched C₁ to C₂₀ cycloalkyl, C₁ to C₂₀ alkyl, C₁ to C₂₀ cycloalkenyl, C₁ to C₂₀ alkenyl, C₁ to C₂₀ cycloalkynyl, C₁ to C₂₀ alkynyl, C₆ to C₂₀ aryl, or C₁ to C₂ alkoxy), NR₆, NR₆R₆, SR₆ or SR₆R₆;
wherein R₂, R₃, R₄, and R₅ are, independently, H, R₆, NR₆, NR₆R₆, NO₂, OH, O₂, fluorine, chlorine, bromine, fluorinated alkyl, fluorinated alkoxy, cyano, carboalkoxy, SR₆ or SR₆R₆; with the proviso that if X is N, then R₂ and R₃ may not be H, or that if X₁ is N, then R₄ and R₅ may not be H;
with the proviso that if X and X₁ are double bonded to each other, if X is doubled bonded to R₂ or if X₁ is double bonded to R₄, then R₃ and R₅ will not exist.

46. The process of claim 44, wherein R₂, R₃, R₄, and/or R₅ in combination with each other or in combination with X and/or X₁, may form an annellated carbo- or heterocyclic, n-membered ring system where n=3 to 10, wherein the annellated carbo- or heterocyclic ring systems may, independently of one another, contain one or more heteroatoms (N, O, S) and may be substituted independently of one another by one or more of the same or different substituents from the following group: H, D, ND or ND₂, NO₂, OH, O₂, fluorine, chlorine, bromine, fluorinated alkyl, fluorinated alkoxy, cyano, carboalkoxy, SD and/or SD₂

47. The process of claim 1, wherein providing an effective amount of catalyst or a salt thereof comprises:
selecting at least one compound from the following group: pyrrole, substituted pyrrole, pyrazole, indazole, substituted indazole, imidazole, substituted imidazole, benzimidazole, substituted benzimidazole, hetero aromatic annellated imidazole, 1,2,4-triazole, substituted 1,2,4-triazole, 1,2,3-triazole, substituted 1,2,3-triazole, heteroaromatic annellated 1,2,3-triazole, isomeric pyridinotriazole, azapurine, substituted adenine, and carbocyclically or a heterocyclically annellated derivative of the listed compounds; and
converting the compound into a carbene or producing a carboxylate complex with the compound.

48. The process of claim 1, wherein providing an effective amount of catalyst or a salt thereof comprises:
selecting at least one compound from the following group: 5-nitroindazole, 4-nitroimidazole, 4-methoxyimidazole, 5-nitrobenzimidazole, 5-methoxybenzimidazole, 2-trifluoromethylbenzimidazole, pyridinoimidazole, 5-bromotriazole, and 1H 1,2,3 triazolo[4,5 b]pyridine; and
converting the compound into a carbene or producing a carboxylate complex with the compound.

49. The process of claim 1, where the isocyanate monomer comprises: 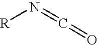
wherein R is H, R₆ (R₆ being branched or unbranched C₁ to C₂₀ cycloalkyl, C₁ to C₂₀ alkyl, C₁ to C₂₀ cycloalkenyl, C₁ to C₂₀ alkenyl, C₁ to C₂₀ cycloalkynyl, C₁ to C₂₀ alkynyl, C₆ to C₂₀ aryl, or C₁ to C₂ alkoxy), NR₆, NR₆R₆, SR₆ or SR₆R₆.

50. The process of claim 1, where the diisocyanate monomer comprises: 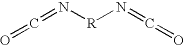
wherein R is H, R₆ (R₆ being branched or unbranched C₁ to C₂₀ cycloalkyl, C₁ to C₂₀ alkyl, C₁ to C₂₀ cycloalkenyl, C₁ to C₂₀ alkenyl, C to C₂₀ cycloalkynyl, C₁ to C₂₀ alkynyl, C₆ to C₂₀ aryl, or C₁ to C₂ alkoxy), N or NR₆, fluorine, chlorine, bromine, fluorinated alkyl, fluorinated alkoxy, cyano, carboalkoxy, SR₆ or SR₆R₆.

51. The process of claim 1, where the triisocyanate monomer comprises: 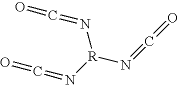
wherein R is H, R₆ (R₆ being branched or unbranched C₁ to C₂₀ cycloalkyl, C₁ to C₂₀ alkyl, C₁ to C₂₀ cycloalkenyl, C₁ to C₂₀ alkenyl, C₁ to C₂₀ cycloalkynyl, C₁ to C₂₀ alkynyl, C₆ to C₂₀ aryl, or C₁ to C₂ alkoxy), N or NR₆, fluorine, chlorine, bromine, fluorinated alkyl, fluorinated alkoxy, cyano, carboalkoxy, SR₆ or SR₆R₆.
